(19) United States
(12) Patent Application Publication
(10) Pub. No.: US 2024/0063615 A1
(43) Pub. Date: Feb. 22, 2024

(54) MULTI-SPEED ELECTRIC JACK FOR LINE PULLING SYSTEMS

(71) Applicant: Sherman + Reilly, Inc., Chattanooga, TN (US)

(72) Inventors: Robert Scott Post, Chattanooga, TN (US); Anthony Maxwell, Chattanooga, TN (US); Lillian Nichole Shelton, Chattanooga, TN (US)

(21) Appl. No.: 18/449,079

(22) Filed: Aug. 14, 2023

Related U.S. Application Data
(60) Provisional application No. 63/400,025, filed on Aug. 22, 2022.

(51) Int. Cl. H02G 1/06; G05D 13/62

(52) U.S. Cl. CPC H02G 1/06; G05D 13/62; B60S 9/04

(57) ABSTRACT

A line pulling system having a chassis, a reel carrier assembly, an electric power source, and an electric jack assembly. The electric jack assembly can include a housing, a leg configured to extend and retract axially from the housing, an electric motor, a current sensor configured to detect a current supplied to the electric motor, and a controller. The controller can receive current data and, if the current is less than a threshold current, supply a first voltage to the electric motor to cause the electric motor to extend or retract the leg at a first speed. If the current is greater than or equal to the threshold current, the controller can supply a second voltage to the electric motor. The second voltage can cause the electric motor to extend or retract the leg at a second speed that is less than the first speed.

### CROSS-REFERENCE TO RELATED APPLICATIONS

This application claims priority under 35 U.S.C. § 119 to U.S. Provisional Patent Application No. 63/400,025, filed 22 Aug. 2022, the entire contents of which are fully incorporated herein by reference.

### STATEMENT REGARDING FEDERALLY SPONSORED RESEARCH OR DEVELOPMENT

Not Applicable

### THE NAMES OF THE PARTIES TO A JOINT RESEARCH AGREEMENT

Not Applicable

### SEQUENCE LISTING

Not Applicable

### STATEMENT REGARDING PRIOR DISCLOSURES BY THE INVENTOR OR A JOINT INVENTOR

Not Applicable

### BACKGROUND OF THE DISCLOSURE

### 1. Field of the Invention

The disclosed technology relates generally to equipment lifting systems; and, more specifically, to electric jacks used for lifting and leveling line pulling systems.

### 2. Description of Related Art

Line pulling equipment is a vital tool in the electrical utility industry. Such equipment can be used to manipulate wires, ropes, cables, and other materials (collectively, “lines”) during installation (e.g., installing new utility lines) and/or reconductoring (e.g., pulling a new conductor through an old utility line). Typically, line pulling equipment can include a puller machine located at one end of a stretch of utility line and a tensioner machine located at the opposite end of the stretch of the utility line. When installing or reconductoring a stretch of utility line, the puller typically pulls the line through sets of sheaves (often referred to as “pulleys” or “blocks”) that are attached to power poles while the tensioner controls a tension applied to the line as it is fed from a spool. In certain examples, utility lines can extend for long distances, greatly increasing the forces and stresses on the line pulling equipment.

Due to the large forces and stresses exerted on the line pulling equipment during a pulling operation, line pulling equipment typically have jacks that are designed to level the line pulling equipment and/or stabilize the line pulling equipment. Jacks are typically designed to extend from a retracted position to an extended position in which the jack contacts the ground and stabilizes the line pulling equipment. Existing jacks can be transitioned between the retracted and the extended positions by manually turning a threaded rod or by depressing a button to cause the jack to be extended or retracted by an electric or hydraulic actuator.

Manual jacks can be cumbersome, time consuming, and difficult for an operator to deploy. Hydraulic actuators require bulky hydraulic systems that add weight and cost to the line pulling equipment. Existing electric jacks, on the other hand, eliminate the additional weight and complexity of a hydraulic system but, like many hydraulic systems, often require user input to change a position of the electric jack which can lead to damage to the equipment or injury to the operator if the operator does not pay close enough attention.

To further complicate matters, line pulling equipment is often used in locations where the ground can be unlevel or soft which can cause the line pulling equipment to shift or move during a pulling or tensioning operation. As a result, the operator must sometimes adjust the jack position to ensure the line pulling equipment remains level. Adjusting the jack position during a pulling or tensioning operation can be dangerous and can slow down the line pulling operation.

What is needed therefore is a jack and leveling system that can automatically adjust the speed of the jack when extending or retracting and automatically level the line pulling equipment to stabilize the line pulling equipment. These and other problems are addressed by examples of the technology disclosed herein.

### SUMMARY

The disclosed technology relates generally to equipment lifting systems; and, more specifically, to electric jacks used for lifting and leveling line pulling systems. The disclosed technology can include a line pulling system having a chassis, a reel carrier assembly attached to the chassis and configured to support a reel having an electrical utility line disposed thereon, an electric power source, and an electric jack assembly.

The electric jack assembly can include a housing attached to the chassis, a leg configured to extend and retract axially from the housing to lift the chassis, and an electric motor in communication with the electric power source and configured to cause the leg to extend and retract axially from the housing. The electric jack assembly can further include a sensor or multiple sensors configured to detect a characteristic of the power supplied to the motor (e.g., a current sensor configured to detect a current supplied to the electric motor), and a controller in communication with the electric power source and the electric motor.

The controller can be configured to receive current data from the current sensor. In response to determining that the detected current is less than a threshold current, the controller can cause a first voltage to be supplied to the electric motor. The first voltage can be configured to cause the electric motor to extend or retract the leg at a first speed. In response to determining that the detected current is greater than or equal to the threshold current, the controller can cause a second voltage to be supplied to the electric motor. The second voltage can be configured to cause the electric motor to extend or retract the leg at a second speed that is less than the first speed.

In response to receiving an extend command, the controller can be further configured to cause the electric motor to begin extending the leg from the housing. In response to receiving a retract command, the controller can be further configured to cause the electric motor to begin retracting the leg to the housing.

The extend command and the retract command can be received from an input device mounted on the line pulling system. The extend command and the retract command can be received from a remote device in communication with the controller.

The line pulling system can include a level sensor (or sensors) that is configured to detect whether the chassis is level. The controller can be further configured to receive level data from the level sensor. In response to determining that the chassis is not level and that the current is less than the threshold current, the controller can be further configured to cause the first voltage to be supplied to the electric motor. In response to determining that the chassis is not level and that the current is greater than or equal to the threshold current, the controller can be further configured to cause the second voltage to be supplied to the electric motor.

The line pulling system can further include a switch configured to cause the electric motor to extend or retract the leg without input from the controller.

The line pulling system can further include a foot attached to the leg and configured to engage the ground to lift the chassis. The foot can be or include a drop foot configured to be extended manually.

Additional features, functionalities, and applications of the disclosed technology are discussed herein in more detail.

### BRIEF DESCRIPTION OF THE DRAWINGS

The accompanying drawings, which are incorporated in and constitute a part of this specification, illustrate multiple examples of the presently disclosed subject matter and serve to explain the principles of the presently disclosed subject matter. The drawings are not intended to limit the scope of the presently disclosed subject matter in any manner.

FIG. 1 is a perspective view of line pulling equipment having a multi-speed jack, in accordance with the disclosed technology.

FIG. 2 is a perspective view of a multi-speed jack, in accordance with the disclosed technology.

FIG. 3 is a flowchart depicting an example method of operating a multi-speed jack, in accordance with some examples of the present disclosure.

FIG. 4 is a flowchart depicting an example method of automatically leveling a multi-speed jack, in accordance with some examples of the present disclosure.

### DETAILED DESCRIPTION

Examples of the present disclosure relate to a multi-speed electric jack that can automatically adjust the speed of the jack depending on whether the jack is loaded or unloaded. For example, the jack can be configured to automatically operate at a high speed when the jack is unloaded (e.g., when first extending the jack before contacting the ground or after the load is taken from the jack when retracting the jack) and at a slow speed when the jack is loaded (e.g., when the jack is supporting the line pulling equipment). In this way, the disclosed technology can enable the line pulling equipment to be lifted quickly and safely while also protecting the jack from damage (motor overload, plastic deformation of the components of the jack 200, damage to the gears in the gear box 222, etc.) that can occur from overloading the jack. The disclosed technology can also be configured to detect whether the line pulling equipment is level and can adjust a position of the jack to ensure the line pulling equipment remains level. For example, the disclosed technology can be configured to extend or retract the jack to ensure the line pulling equipment remains level if the ground beneath the line pulling equipment is soft and the line pulling equipment beings to shift. In this way, the line pulling equipment can be maintained in a level configuration without requiring a user's input.

To facilitate an understanding of the principles and features of the disclosed technology, various illustrative examples are explained below. In particular, the presently disclosed subject matter is described in the context of being a multi-speed electric jack for line pulling equipment. Examples of the present disclosure, however, are not limited to the electric utility industry and can be applicable in other contexts. Other applications can include, for example, general construction, road surfacing equipment, farming equipment, industrial manufacturing, mining, automotive applications, and any other industry or application which commonly uses jacks. These examples are contemplated within the scope of the present disclosure. Accordingly, when the present disclosure is described in the context of a multi-speed electric jack for line pulling equipment, it will be understood that other examples can take the place of those referred to.

It must also be noted that, as used in the specification and the appended claims, the singular forms “a,” “an” and “the” include plural references unless the context clearly dictates otherwise. For example, reference to a component is intended also to include composition of a plurality of components. References to a composition containing “a” constituent is intended to include other constituents in addition to the one named. In other words, the terms “a,” “an,” and “the” do not denote a limitation of quantity, but rather denote the presence of “at least one” of the referenced item.

As used herein, the term “and/or” may mean “and,” it may mean “or,” it may mean “exclusive-or,” it may mean “one,” it may mean “some, but not all,” it may mean “neither,” and/or it may mean “both.” The term “or” is intended to mean an inclusive “or.”

Also, in describing the exemplary embodiments, terminology will be resorted to for the sake of clarity. It is intended that each term contemplates its broadest meaning as understood by those skilled in the art and includes all technical equivalents which operate in a similar manner to accomplish a similar purpose. It is to be understood that embodiments of the disclosed technology may be practiced without these specific details. In other instances, well-known methods, structures, and techniques have not been shown in detail in order not to obscure an understanding of this description. References to “one embodiment,” “an embodiment,” “example embodiment,” “some embodiments,” “certain embodiments,” “various embodiments,” etc., indicate that the embodiment(s) of the disclosed technology so described may include a particular feature, structure, or characteristic, but not every embodiment necessarily includes the particular feature, structure, or characteristic. Further, repeated use of the phrase “in one embodiment” does not necessarily refer to the same embodiment, although it may.

Ranges may be expressed herein as from “about” or “approximately” or “substantially” one particular value and/or to “about” or “approximately” or “substantially” another particular value. When such a range is expressed, other exemplary embodiments include from the one particular value and/or to the other particular value. Further, the term “about” means within an acceptable error range for the particular value as determined by one of ordinary skill in the art, which will depend in part on how the value is measured or determined, i.e., the limitations of the measurement system. For example, “about” can mean within an acceptable standard deviation, per the practice in the art. Alternatively, “about” can mean a range of up to ±20%, preferably up to ±10%, more preferably up to ±5%, and more preferably still up to ±1% of a given value. Alternatively, the term can mean within an order of magnitude, preferably within 2-fold, of a value. Where particular values are described in the application and claims, unless otherwise stated, the term “about” is implicit and in this context means within an acceptable error range for the particular value.

Throughout this disclosure, various aspects of the disclosure can be presented in a range format. It should be understood that the description in range format is merely for convenience and brevity and should not be construed as an inflexible limitation on the scope of the disclosure. Accordingly, the description of a range should be considered to have specifically disclosed all the possible subranges as well as individual numerical values within that range. For example, description of a range such as from 1 to 6 should be considered to have specifically disclosed subranges such as from 1 to 3, from 1 to 4, from 1 to 5, from 2 to 4, from 2 to 6, from 3 to 6 etc., as well as individual numbers within that range, for example, 1, 2, 2.7, 3, 4, 5, 5.3, and 6. This applies regardless of the breadth of the range.

By “comprising” or “containing” or “including” is meant that at least the named compound, element, particle, or method step is present in the composition or article or method, but does not exclude the presence of other compounds, materials, particles, method steps, even if the other such compounds, material, particles, method steps have the same function as what is named.

Throughout this description, various components may be identified having specific values or parameters, however, these items are provided as exemplary embodiments. Indeed, the exemplary embodiments do not limit the various aspects and concepts of the present disclosure as many comparable parameters, sizes, ranges, and/or values may be implemented. The terms “first,” “second,” and the like, “primary,” “secondary,” and the like, do not denote an order, quantity, or importance, but rather are used to distinguish one element from another.

It is noted that terms like “specifically,” “preferably,” “typically,” “generally,” and “often” are not utilized herein to limit the scope of the claimed disclosure or to imply that certain features are critical, essential, or even important to the structure or function of the claimed disclosure. Rather, these terms are merely intended to highlight alternative or additional features that may or may not be utilized in a particular embodiment of the present disclosure. It is also noted that terms like “substantially” and “about” are utilized herein to represent the inherent degree of uncertainty that may be attributed to any quantitative comparison, value, measurement, or other representation.

The dimensions and values disclosed herein are not to be understood as being strictly limited to the exact numerical values recited. Instead, unless otherwise specified, each such dimension is intended to mean both the recited value and a functionally equivalent range surrounding that value. For example, a dimension disclosed as “50 mm” is intended to mean “about 50 mm.”

It is also to be understood that the mention of one or more method steps does not preclude the presence of additional method steps or intervening method steps between those steps expressly identified. Furthermore, although the various methods may be shown and described herein as having a particular order, it will be appreciated by one of skill in the art that the method steps shown and described can be rearranged in various other orders without departing from the scope of this disclosure. Similarly, it is also to be understood that the mention of one or more components in a composition does not preclude the presence of additional components than those expressly identified.

The materials described hereinafter as making up the various elements of the present disclosure are intended to be illustrative and not restrictive. Many suitable materials that would perform the same or a similar function as the materials described herein are intended to be embraced within the scope of the disclosure. Such other materials not described herein can include, but are not limited to, materials that are developed after the time of the development of the disclosure, for example. Any dimensions listed in the various drawings are for illustrative purposes only and are not intended to be limiting. Other dimensions and proportions are contemplated and intended to be included within the scope of the disclosure.

The components described hereinafter as making up various elements of the disclosed technology are intended to be illustrative and not restrictive. Many suitable components that would perform the same or similar functions as the components described herein are intended to be embraced within the scope of the disclosed technology. Such other components not described herein can include, but are not limited to, similar components that are developed after development of the presently disclosed subject matter.

Referring now to the drawings, in which like numerals represent like elements, example embodiments of the present disclosure are herein described.

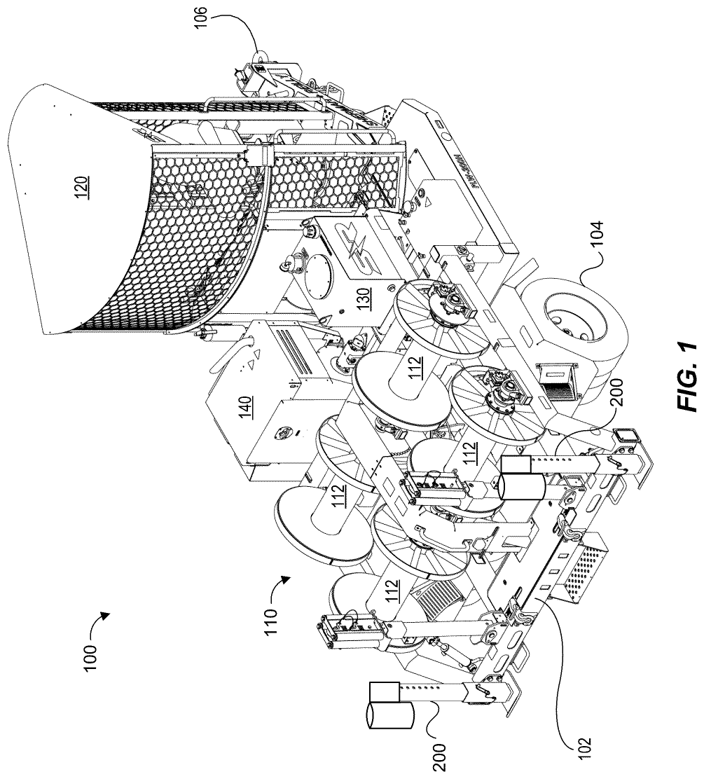

Turning now to the drawings in which like references represent like elements, FIG. 1 illustrates a line pulling system 100 (sometimes referred to herein as line puling equipment) that can include a chassis 102 having wheels 104. In some examples, the chassis 102 can include a trailer hitch 106 but it will be appreciated that other types of chassis 102, including motor vehicles, are contemplated.

A reel carrier assembly 110 can be attached to the chassis 102 and can be configured to support one or more reels 112 (e.g., line pulling drums). The chassis 102 can be further configured to support an operator station 120, a hydraulic system 130, and a motor 140 depending on the particular configuration. The motor 140 can be configured to power some, or all, of the components discussed herein. In some examples, the motor 140 can be configured to cause the reel carrier assembly 110 to rotate the reels 112 in a first direction to receive the line and in a second direction to facilitate removal of the line from the one or more reels 112. As will be appreciated by one of skill in the art, the line pulling system 100 illustrated in FIG. 1 is offered for illustrative purposes and other line pulling or tensioning systems are contemplated. For example, the line pulling system 100 can be a bullwheel tensioner, a pilot line winder, a reel carrier, or any other type of line pulling equipment.

As shown, the line pulling equipment can include one or more jacks 200 (sometimes referred to herein as a multi-speed jack) that can be attached to the chassis 102 and be configured to lift and support the line pulling system 100. In the example shown in FIG. 1, the jacks 200 can be attached to the chassis 102 near a rear end of the chassis 102. As will be appreciated, the line pulling system 100 can include multiple jacks 200 positioned around the chassis 102 at location where the jacks 200 can provide support to the line pulling system 100. For example, the jacks 200 can be positioned near the rear, the front, or the sides of the line pulling system 100 to lift and stabilize the line pulling system 100 depending on the particular type and configuration of the line pulling system 100.

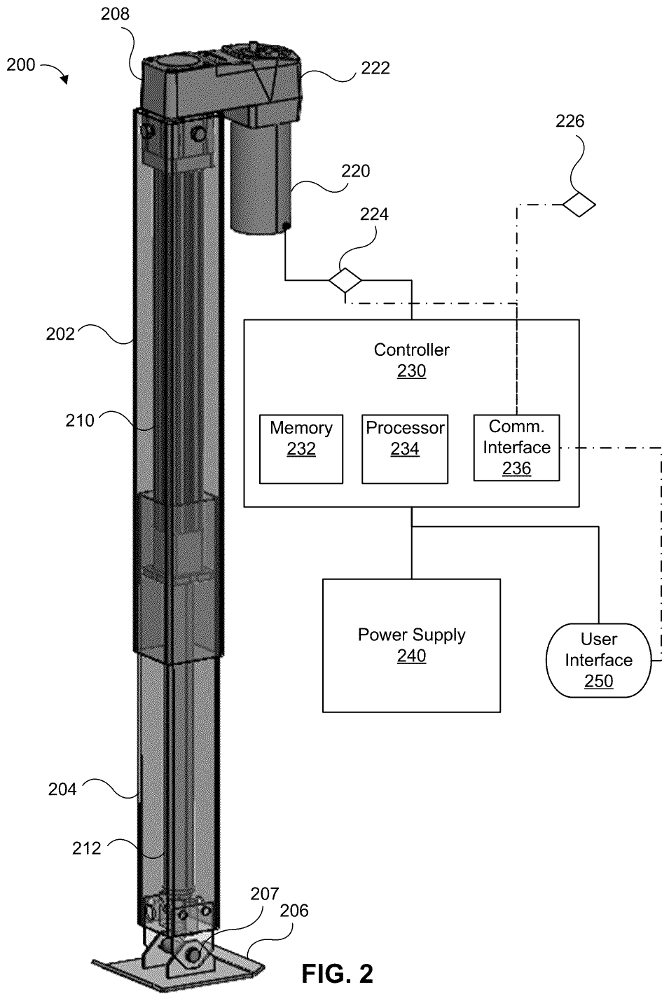

As illustrated in FIG. 2, the jacks 200, can include a housing 202, leg 204, and a foot 206. The housing 202 can be attached to the chassis 102 and can be configured to receive the leg 204 such that the leg can slide into, and out of, the housing 202. The foot 206 can be wider or have a greater area parallel to the ground than the housing 202 or the leg 204 such that the foot 206 can distribute pressure at a location where the foot contacts the ground. In this way, the foot 206 can help to prevent the foot 206 from sinking into the ground due to the weight of the line pulling system 100. The foot 206 can also be attached to the leg 204 by a hinged joint 207 to allow the foot 206 to rotate in relation to the leg 204. In this way, the foot 206 can facilitate use of the jack 200 when the ground is not perfectly flat or if the ground becomes unstable. Furthermore, the foot 206 can include an extension portion such that the foot can be a drop foot. In other words, at least a portion of the foot 206 can be manually extended to elongate the length of the jack 200. This can help to further speed up the process of extending the jack 200 to lift the line pulling equipment 100.

The jack 200 can include a linear actuator 208 having a driving element 210 and a driven element 212. The driving element 210 can be disposed at least partially within the housing 202 and the driven element 212 can be disposed at least partially within the leg 204. At least a portion of the driving element 210 can be configured to cause the driven element 212 to extend or retract relative to the driving element 210 such that the leg 204 can extend or retract from the housing 202. In this way, the jack 200 can be configured to transition between a retracted position and an extended position to lift or lower the line pulling system 100. Although described throughout this disclosure as being a linear actuator, the disclosed technology can include a scissor lift, a smart cylinder, a linear servo, or any other type of actuator without departing from the scope of this disclosure.

The jack 200 can further include an electric motor 220 that can be in mechanical communication with the driving element 210 via a gear box 222. The electric motor 220 can be configured to cause the linear actuator 208 to move the driving element 210 in a first direction to cause the driven element 212 to extend outwardly from the driving element 210 and in a second direction to cause the driven element 212 to retract inwardly toward the driving element 210. The motor 220 can be configured to operate a multiple different speeds depending on the voltage supplied to the motor 220. For example, the motor 220 can be configured to rotate an output shaft of the motor at a first speed when a first voltage is supplied and at a second, greater speed when a second, greater voltage is supplied. As will be appreciated, the speed at which the output shaft is rotated by the motor 220 will affect the speed at which the jack 200 is extended or retracted. The electric motor 220 can be any suitable type of electric motor. As non-limiting examples, the electric motor 220 can be a brushless or bushed motor and can be configured to be powered by alternating current or direct current.

The gear box 222 can be configured to transfer mechanical energy from an output shaft of the electric motor 220 to the driving element 210 in a direct 1:1 relation or in any other suitable gear ratio depending on the particular configuration and the expected weight to be lifted. The gear box 222 can additionally be configured to affect the speed at which the jack 200 extends or retracts. For example, the gear box 222 can have a first gear setting that extends or retracts the jack 200 at a first speed and a second gear setting that extends or retracts the jack 200 at a second, faster speed.

The line pulling system 100 can include a controller 230 that can be configured to receive data and determine actions based on the received data. For example, the controller 230 can be configured to receive an input from a user interface 250 such as a command to raise or lower the jack 200. The user interface 250 can be a simple switch or other electronic device configured to provide an input to the controller 230 such as a human-machine interface, a computer, etc. The user interface 250 can be in communication with the controller 230 via a communication interface 236. The communication interface 236 can be directly wired to the user interface 250, wirelessly connected to the communication interface 250, or both. Upon receiving an input from the user interface 250, the controller 230 can determine what actions to take in accordance with the methods described further herein. In some examples, the user interface 250, or an additional switch, can be directly connected between the power supply 240 and the electric motor 220 to allow the jack 200 to be extended or retracted without the controller 230. This can be useful, for example, if the controller 230 fails and the jack 200 still needs to be extended or retracted.

The controller 230 and the electric motor 220 can be powered by a power supply 240. The power supply 240 can be a battery, a capacitor bank, an electric utility grid, a generator, or any other suitable power supply for the particular application.

The line pulling system 100 can further include a current sensor 224 configured to detect a current of the electrical power supplied to the electric motor 220. The current sensor 224 can be any type of current sensor suitable for the particular application. For example, the current sensor 224 can be a hall effect sensor, and inductive sensor, a magnetoresistive sensor, a current transducer (CT), a Rogowski coil, a flux gate, etc. The current sensor 224 can be in communication with the controller 230 and output current data to the controller 230. The current data, for example, can be indicative of the current of the electrical power supplied to the electric motor 220.

The line pulling system 100 can include a level sensor 226 that can be configured to detect whether the chassis 102 is level. For example, the level sensor 226 can determine if the chassis 102 is generally oriented such that a front, rear, and sides of the chassis are generally at the same elevation to ensure the reel carrier assembly is generally horizontal or otherwise perpendicular to a direction of the gravitational force acting on the line pulling system 100. In this way, the line pulling system 100 can be properly positioned when performing a stringing operation. The level sensor 226 can be any suitable type of sensor, or combination of sensors, that is capable of detecting whether the chassis 102 is level. For example, the level sensor 226 can be an accelerometer, a gyrometer, an altimeter, an inclinometer, a tilt/slope sensor, radar, light detection and ranging (LiDAR), laser, ultrasonic sensor, or any other suitable type of sensor. The level sensor 226 (or multiple level sensors 226) can output level data to the controller 230 indicative of whether the chassis 102 is currently level. The controller 230 can then analyze the level data to determine if the chassis's 102 position needs to be adjusted (e.g., in a direction of roll and/or pitch) and can then output instructions to the jack 200 to adjust the position of the chassis 102 to ensure the chassis 102 is level.

The controller 230 can have a memory 232, a processor 234, and a communication interface 236. The controller 230 can be a computing device configured to receive data, determine actions based on the received data, and output a control signal instructing the electric motor 220 to perform one or more actions. One of skill in the art will appreciate that the controller 230 can be installed in any location, provided the controller 230 is in communication with at least some of the components of the line pulling system 100. Furthermore, the controller 230 can be configured to send and receive wireless or wired signals and the signals can be analog or digital signals. The wireless signals can include Bluetooth™, BLE, WiFi™, ZigBee™, infrared, microwave radio, or any other type of wireless communication as may be suitable for the particular application. The hard-wired signal can include any directly wired connection between the controller and the other components described herein. Alternatively, the components can be powered directly from a power source and receive control instructions from the controller 230 via a digital connection. The digital connection can include a connection such as an Ethernet or a serial connection and can utilize any suitable communication protocol for the application such as Modbus, fieldbus, PROFIBUS, SafetyBus p, Ethernet/IP, or any other suitable communication protocol for the application. Furthermore, the controller 230 can utilize a combination of wireless, hard-wired, and analog or digital communication signals to communicate with and control the various components. One of skill in the art will appreciate that the above configurations are given merely as non-limiting examples and the actual configuration can vary depending on the particular application.

The controller 230 can include a memory 232 that can store a program and/or instructions associated with the functions and methods described herein and can include one or more processors 234 configured to execute the program and/or instructions. The memory 232 can include one or more suitable types of memory (e.g., volatile or non-volatile memory, random access memory (RAM), read only memory (ROM), programmable read-only memory (PROM), erasable programmable read-only memory (EPROM), electrically erasable programmable read-only memory (EEPROM), magnetic disks, optical disks, floppy disks, hard disks, removable cartridges, flash memory, a redundant array of independent disks (RAID), and the like) for storing files including the operating system, application programs (including, for example, a web browser application, a widget or gadget engine, and or other applications, as necessary), executable instructions and data. One, some, or all of the processing techniques or methods described herein can be implemented as a combination of executable instructions and data within the memory.

The controller 230 can also have a communication interface 236 for sending and receiving communication signals between the various components. Communication interface 236 can include hardware, firmware, and/or software that allows the processor(s) 234 to communicate with the other components via wired or wireless networks, whether local or wide area, private or public, as known in the art. Communication interface 236 can also provide access to a cellular network, the Internet, a local area network, or another wide-area network as suitable for the particular application.

Additionally, the controller 230 can have or be in communication with the user interface 250 for displaying system information and receiving inputs from a user. The user interface 250 can be installed locally or be a remotely controlled device such as a mobile device. The user, for example, can view system data on the user interface 250 and input data or commands to the controller 230 via the user interface 250. As non-limiting examples, the user can view jack 200 position, current or voltage values supplied to the electric motor 220, whether the chassis 102 is level, etc. The user can also provide inputs to the controller 230 via the user interface 250 to change a position of the jack 200 to enable lifting or lowering of the line pulling system 100.

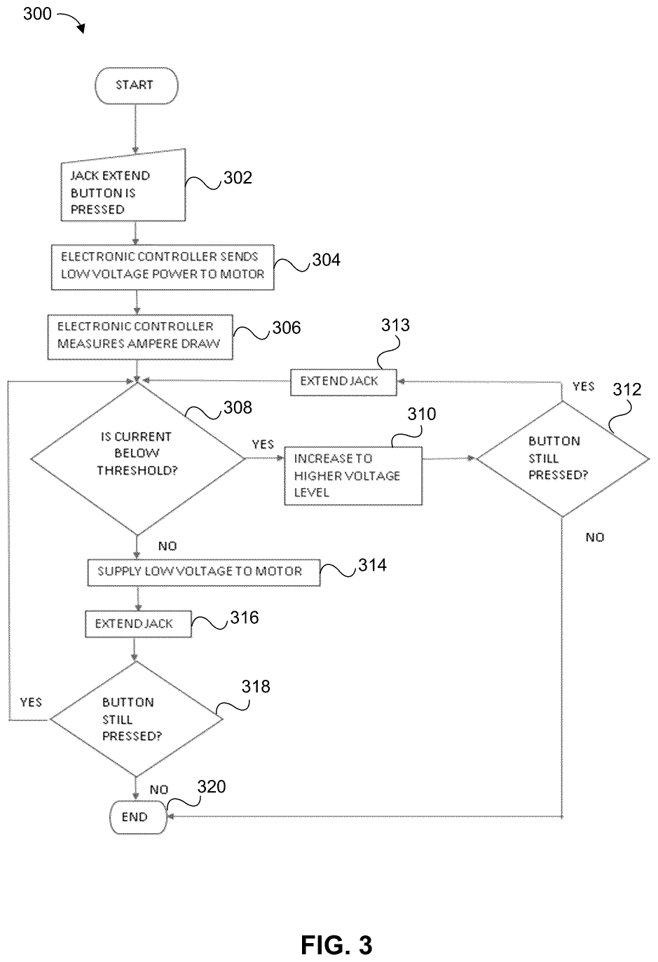

FIG. 3 illustrates a flowchart depicting an example of a method 300 of operating a multi-speed jack 200. As will become apparent, the method 300 can be implemented or executed by the controller 230 to cause the jack 200 to automatically change speeds at which the jack 200 lifts the line pulling system 100. To illustrate, it can be preferable to raise or lower the jack 200 at a fast speed when the jack 200 is unloaded and at a second speed when the jack 200 is loaded. As will be appreciated, the forces acting upon the jack 200 are greatly increased when the jack 200 begins to lift the weight of the line pulling system 100 and raising the line pulling system 100 at a slower speed can help to reduce damage to the jack 200, the line pulling system 100, and potential injury to the user.

The method 300, as executed or implemented by the controller 230, can begin by determining 302 if a jack extend button is pressed (e.g., whether a user has pressed a button, provided an input via an input device, or otherwise indicated via the user interface 250 that the jack 200 should be extended—an extend command) The method 300 can include sending 304 low voltage power to the electric motor 220 to begin lowering the jack 200 at a first, slow speed. The method 300 can include measuring 306 the ampere draw of the electric motor 220 (e.g., the controller 230 can receive current data from the current sensor 224 and determine the how much current the motor is drawing).

The method 300 can include determining 308 if the current is below a threshold current. The threshold current can be a predetermined current at which the jack 200 is likely to begin lifting at least some weight of the line pulling system 100. If the current is below the threshold current, the method 300 can include increasing 310 the voltage supplied to the electric motor 220 to begin extending the jack 200 at a second, faster speed. As will be appreciated, if the detected current is less than the threshold current, the jack 200 is not likely to be lifting the line pulling system 100 and, therefore, it can be desirable to extend the jack 200 quickly (e.g., when first lowering the jack 200 before it contacts the ground).

In some examples, the method 300 can include determining 312 if the jack extend button is still pressed. If the jack extend button is still pressed, the method can include continuing 313 to extend the jack 200. If the jack extend button is no longer pressed, the method 300 can include ending 320 the extension of the jack 200. In some examples, the step of determining 312 if a jack extend button is still pressed can be omitted and the jack 200 can be configured to continue extending without direct user input (i.e., the user would not need to continue holding the button to cause the jack 200 to extend). In other examples, the jack extend button can be a switch that will remain in the extend position until a user moves the switch to a stop or retract position.

If the current is greater than or equal to the threshold current, the method 300 can include continuing 314 to supply low voltage to the electric motor 220 to extend 316 the jack 200 at the first, slower speed. As will be appreciated, if the detected current is equal to or greater than the threshold current it is likely that the jack 200 has begun to lift the line pulling equipment 100 and it can be desirable to raise the line pulling equipment 100 at the first, slower speed to ensure the jack 200 or the line pulling equipment 100 does not become damaged or to prevent injury. The method 300 can include determining 318 if the jack extend button is still pressed. If the jack extend button is still pressed, the method 300 can include once again determining 308 if the current is below a threshold current. If the jack extend button is no longer pressed, the method 300 can include ending 320 the extension of the jack 200. As above, in some examples, the step of determining 318 if a jack extend button is still pressed can be omitted and the jack 200 can be configured to continue extending without direct user input (i.e., the user would not need to continue holding the button to cause the jack 200 to extend). In other examples, the jack extend button can be a switch that will remain in the extend position until a user moves the switch to a stop or retract position.

As will be appreciated, the method 300 can be repeated until the jack 200 has extended to the desired length and the line pulling equipment 100 is properly supported by the jack 200. Furthermore, rather than using a current sensor 224 to detect a current drawn by the electric motor 220, other sensors can be used to determine if the jack 200 has begun to lift the line pulling equipment 100. For example, the disclosed technology can include a limit switch, position sensor, pressure sensor, or other similar sensors or switches that can provide an indication to the controller 230 that the jack 200 has begun to lift the line pulling equipment 100.

Furthermore, FIG. 3 only illustrates a method 300 of extending the jack 200 (i.e., lifting the line pulling system 100), but it will be appreciated by one of skill in the art that similar principals can be applied to retract the jack 200 (i.e., lower the line pulling system 100). In other words, the disclosed technology can similarly include a method of retracting the jack 200. For example, the method 300 can include determining if a jack retract button is pressed (a retract command) and sending 304 low voltage to the electric motor 220 to begin retracting the jack 200 at the first, slow speed. If the current is less than the threshold current, the method 300 can include increasing 310 the voltage to a higher voltage to retract the jack 200 faster. All other steps can be the same except that that the jack 200 will be retracting rather than extending.

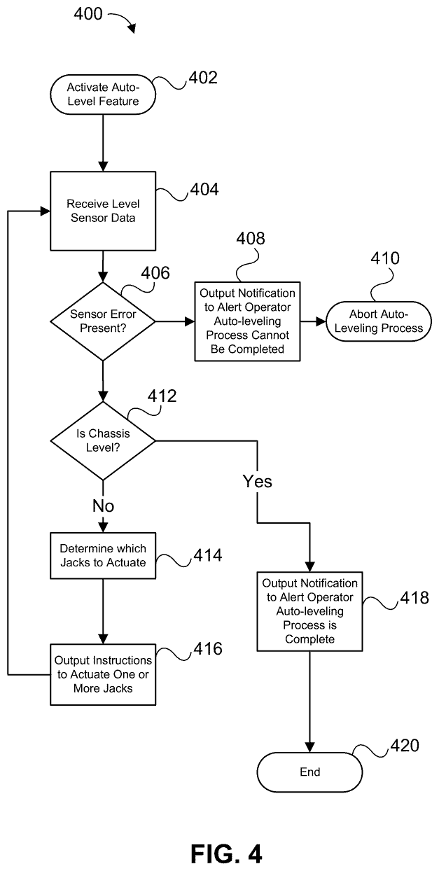

As described above, the disclosed technology can be further configured to automatically level the chassis 102 to ensure the line pulling equipment is properly leveled and positioned. As illustrated in FIG. 4, the disclosed technology can include a method 400 of automatically leveling the chassis 102. The method 400 can include activating 402 an auto-leveling feature by either a user input (e.g., via a button, a switch, a user interface, etc.) or by the controller 230 determining that the chassis 102 is not level. The method 400 can include receiving 404 level sensor data from the level sensor 226 (or multiple level sensors 226).

The method 400 can include determining 406 if a sensor error is present. Determining 406 if a sensor error is present, for example, can include determining if each sensor 226 is communicating with the controller 230, determining if an error message has been received by the controller 230 from the sensor 226, and/or whether data received from each sensor 226 is within a predetermined range (e.g., outlying data can be indicative of a faulty sensor 226). Determining 406 if a sensor error is present can help to prevent over-extending a particular jack 200 which can cause the chassis 102 to become unstable and could potentially lead to injury.

If a sensor error is present, the method 400 can include outputting 408 a notification to alert an operator that the auto-leveling process cannot be completed. The method 400 can further include aborting 410 the auto-leveling process if a sensor error is present.

The method 400 can include determining 412 if the chassis is level based on the data received from the sensor 226 (or multiple sensors 226). If the chassis 102 is level, the method 400 can include outputting 418 a notification to notify an operator that the auto-leveling process is complete and then ending 420 the method 400 as there is no need to adjust the position of the chassis 102.

If the chassis 102 is not level, the method 400 can include determining 414 which jacks 200 should be actuated to bring the chassis 102 into a level position. Determining 414 which jacks 200 should be actuated can include, for example, determining which side or end of the chassis 102 should be raised or lowered to bring the chassis 102 into a level position based on the data received from the level sensor 226. For example, if the controller 230 determines that the front right corner of the chassis should be raised based on the data received from the level sensor, the controller 230 can determine that either the jack 200 nearest the front right corner should be raised or that one or more of the remaining jacks 200 should be lowered.

In response to determining 414 which jacks 200 should be actuated, the method 400 can include outputting 416 instructions to actuate one or more jacks 200. The one or more jacks 200 can be the jacks 200 determined by the controller 230 should be actuated to bring the chassis 102 into a level position. The jacks 200 can then be extended. Extending the jacks 200 can include some or all of the features of method 300 previously described.

The method 400 can then include once again receiving 404 level sensor data and determining 406 if a sensor error is present. Again, if no sensor error is present, the method 400 can include determining 412 if the chassis 102 is level. As before, if the chassis 102 is level, the method 400 can end 412. Otherwise, the method 400 can include once again determining 414 which jacks 200 should be actuated and outputting 416 instructions to actuate one or more jacks 200 until the chassis 102 is level.

While the present disclosure has been described in connection with a plurality of example aspects, as illustrated in the various figures and discussed above, it is understood that other similar aspects can be used, or modifications and additions can be made to the described subject matter for performing the same function of the present disclosure without deviating therefrom. In this disclosure, methods and compositions were described according to aspects of the presently disclosed subject matter. But other equivalent methods or compositions to these described aspects are also contemplated by the teachings herein. Therefore, the present disclosure should not be limited to any single aspect, but rather construed in breadth and scope in accordance with the appended claims. Moreover, various aspects of the disclosed technology have been described herein as relating to methods, systems, mechanism, mechanisms, and/or non-transitory, computer-readable medium storing instructions. However, it is to be understood that the disclosed technology is not necessarily limited to the examples and embodiments expressly described herein. That is, certain aspects of a described system can be included in the methods described herein, aspects of a described mechanism or system can be included in another mechanism or system, various aspects of a described method can be included in a system described herein, and the like.

What is claimed is:

1. A line pulling system comprising:
a chassis;
a reel carrier assembly attached to the chassis and configured to support a reel having an electrical utility line disposed thereon;
an electric power source; and
an electric jack assembly comprising:
a housing attached to the chassis;
a leg configured to extend and retract axially from the housing to lift the chassis;
an electric motor in communication with the electric power source and configured to cause the leg to extend and retract axially from the housing;
a current sensor configured to detect a current supplied to the electric motor; and
a controller in communication with the electric power source and the electric motor, the controller configured to:
receive current data from the current sensor;
in response to determining that the detected current is less than a threshold current, cause a first voltage to be supplied to the electric motor, the first voltage being configured to cause the electric motor to extend or retract the leg at a first speed; and
in response to determining that the detected current is greater than or equal to the threshold current, cause a second voltage to be supplied to the electric motor, the second voltage being configured to cause the electric motor to extend or retract the leg at a second speed that is less than the first speed.

2. The line pulling system claim 1, wherein the controller is further configured to:
in response to receiving an extend command, cause the electric motor to begin extending the leg from the housing.

3. The line pulling system claim 2, wherein the controller is further configured to:
in response to receiving a retract command, cause the electric motor to begin retracting the leg to the housing.

4. The line pulling system of claim 3 further comprising a user interface in communication with the controller, the user interface configured to receive an input from a user.

5. The line pulling system of claim 4, wherein the extend command and the retract command are received from the user interface, the user interface being mounted on the line pulling system.

6. The line pulling system of claim 3, wherein the extend command and the retract command are received from the user interface, the user interface being remote from the line pulling system.

7. The line pulling system of claim 1 further comprising a level sensor configured to detect whether the chassis is level.

8. The line pulling system of claim 7, the controller being further configured to:
receive level data from the level sensor;
in response to determining that the chassis is not level and that the current is less than the threshold current, cause the first voltage to be supplied to the electric motor.

9. The line pulling system of claim 8, the controller being further configured to:
in response to determining that the chassis is not level and that the current is greater than or equal to the threshold current, cause the second voltage to be supplied to the electric motor.

10. The line pulling system of claim 1 further comprising a switch configured to cause the electric motor to extend or retract the leg without input from the controller.

11. The line pulling system of claim 1 further comprising a foot attached to the leg, the foot configured to engage the ground to lift the chassis.

12. The line pulling system of claim 11, wherein the foot comprises a drop foot configured to be extended manually.

13. The line pulling system of claim 1, wherein the electric power source comprises a battery.

14. The line pulling system of claim 1, wherein the controller is further configured to:
determine whether a sensor error is present; and
in response to determining that a sensor error is present, output a notification indicative the line pulling system being unable to complete an auto-leveling process.

15. The line pulling system of claim 14, wherein the sensor error comprises an indication that one or more level sensors are in operable.

16. A line pulling system comprising:
a chassis;
a reel carrier assembly attached to the chassis and configured to support a reel having an electrical utility line disposed thereon;
an electric power source;
a level sensor configured to detect whether the chassis is level; and
an electric jack assembly comprising:
a housing attached to the chassis;
a leg configured to extend and retract axially from the housing to lift the chassis;
an electric motor in communication with the electric power source and configured to cause the leg to extend and retract axially from the housing; and
a controller in communication with the electric power source and the electric motor, the controller configured to:
receive level data from the level sensor; and
in response to determining that the chassis is not level, cause a voltage to be supplied to the electric motor to extend or retract the leg.

17. The line pulling system of claim 16 further comprising a plurality of electric jack assemblies.

18. The line pulling system of claim 17, wherein the controller is further configured to:
determine, based at least in part on the level data, which electric jack assembly of the plurality of electric jack assemblies needs to be actuated; and
cause a voltage to be supplied to the determined electric jack to extend or retract the leg.

19. The line pulling system of claim 16 further comprising a current sensor configured to detect a current supplied to the electric motor.

20. The line pulling system of claim 19, wherein the controller is further configured to:
receive current data from the current sensor;
in response to determining that the detected current is less than a threshold current, cause a first voltage to be supplied to the electric motor, the first voltage being configured to cause the electric motor to extend or retract the leg at a first speed; and
in response to determining that the detected current is greater than or equal to the threshold current, cause a second voltage to be supplied to the electric motor, the second voltage being configured to cause the electric motor to extend or retract the leg at a second speed that is less than the first speed.
